(19) United States
(12) Patent Application Publication
(10) Pub. No.: US 2024/0346779 A1
(43) Pub. Date: Oct. 17, 2024

(54) DYNAMIC ALIGNMENT BETWEEN SEE-THROUGH CAMERAS AND EYE VIEWPOINTS IN VIDEO SEE-THROUGH (VST) EXTENDED REALITY (XR)

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 18/630,767

(22) Filed: Apr. 9, 2024

Related U.S. Application Data
(60) Provisional application No. 63/459,139, filed on Apr. 13, 2023.

(51) Int. Cl. G06T 19/00; G06T 5/80; H04N 13/344

(52) U.S. Cl. CPC G06T 19/006; G06T 5/80; H04N 13/344

(57) ABSTRACT

A method includes determining that an inter-pupillary distance (IPD) between display lenses of a video see-through (VST) extended reality (XR) device has been adjusted with respect to a default IPD. The method also includes obtaining an image captured using a see-through camera of the VST XR device. The see-through camera is configured to capture images of a three-dimensional (3D) scene. The method further includes transforming the image to match a viewpoint of a corresponding one of the display lenses according to a change in IPD with respect to the default IPD in order to generate a transformed image. The method also includes correcting distortions in the transformed image based on one or more lens distortion coefficients corresponding to the change in IPD in order to generate a corrected image. In addition, the method includes initiating presentation of the corrected image on a display panel of the VST XR device.

### CROSS-REFERENCE TO RELATED APPLICATIONS AND PRIORITY CLAIM

This application claims priority under 35 U.S.C. § 119 (e) to U.S. Provisional Patent Application No. 63/459,139 filed on Apr. 13, 2023. This provisional patent application is hereby incorporated by reference in its entirety.

### TECHNICAL FIELD

This disclosure relates generally to extended reality (XR) systems and processes. More specifically, this disclosure relates to dynamic alignment between see-through cameras and eye viewpoints in video see-through (VST) XR.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to dynamic alignment between see-through cameras and eye viewpoints in video see-through (VST) extended reality (XR).

In a first embodiment, a method includes determining, using at least one processing device, that an inter-pupillary distance (IPD) between left and right display lenses of a VST XR device has been adjusted with respect to a default IPD of the VST XR device. The method also includes obtaining, using the at least one processing device, an image captured using a see-through camera of the VST XR device, where the see-through camera is configured to capture images of a three-dimensional (3D) scene. The method further includes transforming, using the at least one processing device, the image to match a viewpoint of a corresponding one of the display lenses according to a change in IPD with respect to the default IPD in order to generate a transformed image. The method also includes correcting, using the at least one processing device, distortions in the transformed image based on one or more lens distortion coefficients corresponding to the change in IPD in order to generate a corrected image. In addition, the method includes initiating, using the at least one processing device, presentation of the corrected image on a display panel of the VST XR device.

In a second embodiment, a VST XR device includes left and right see-through cameras configured to capture images of a 3D scene, a display panel configured to present virtual images, and left and right display lenses. The VST XR device also includes at least one processing device configured to determine that an IPD between the left and right display lenses has been adjusted with respect to a default IPD of the VST XR device. The at least one processing device is also configured to obtain a specified one of the images captured using a specified one of the see-through cameras. The at least one processing device is further configured to transform the specified image to match a viewpoint of a corresponding one of the display lenses according to a change in IPD with respect to the default IPD in order to generate a transformed image. The at least one processing device is also configured to correct distortions in the transformed image based on one or more lens distortion coefficients corresponding to the change in IPD in order to generate a corrected image. In addition, the at least one processing device is configured to initiate presentation of the corrected image on the display panel.

In a third embodiment, a non-transitory machine readable medium contains instructions that when executed cause at least one processor of a VST XR device to determine that an IPD between left and right display lenses of the VST XR device has been adjusted with respect to a default IPD of the VST XR device. The non-transitory machine readable medium also contains instructions that when executed cause the at least one processor to obtain an image captured using a see-through camera of the VST XR device, where the see-through camera is configured to capture images of a 3D scene. The non-transitory machine readable medium further contains instructions that when executed cause the at least one processor to transform the image to match a viewpoint of a corresponding one of the display lenses according to a change in IPD with respect to the default IPD in order to generate a transformed image. The non-transitory machine readable medium also contains instructions that when executed cause the at least one processor to correct distortions in the transformed image based on one or more lens distortion coefficients corresponding to the change in IPD in order to generate a corrected image. In addition, the non-transitory machine readable medium contains instructions that when executed cause the at least one processor to initiate presentation of the corrected image on a display panel of the VST XR device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2 through 4 illustrate example arrangements of see-through cameras and eye viewpoints in video see-through (VST) extended reality (XR) in accordance with this disclosure;

FIG. 5 illustrates an example architecture supporting dynamic alignment between see-through cameras and eye viewpoints in VST XR in accordance with this disclosure;

FIGS. 6 through 8 illustrate example dynamic alignments between see-through cameras and eye viewpoints in VST XR in accordance with this disclosure;

FIGS. 9 through 11 illustrate example arrangements of principal points associated with VST XR in accordance with this disclosure;

FIG. 12 illustrates an example architecture supporting dynamic distortion correction in VST XR in accordance with this disclosure; and

FIG. 13 illustrates an example method for dynamic alignment between see-through cameras and eye viewpoints in VST XR in accordance with this disclosure.

### DETAILED DESCRIPTION

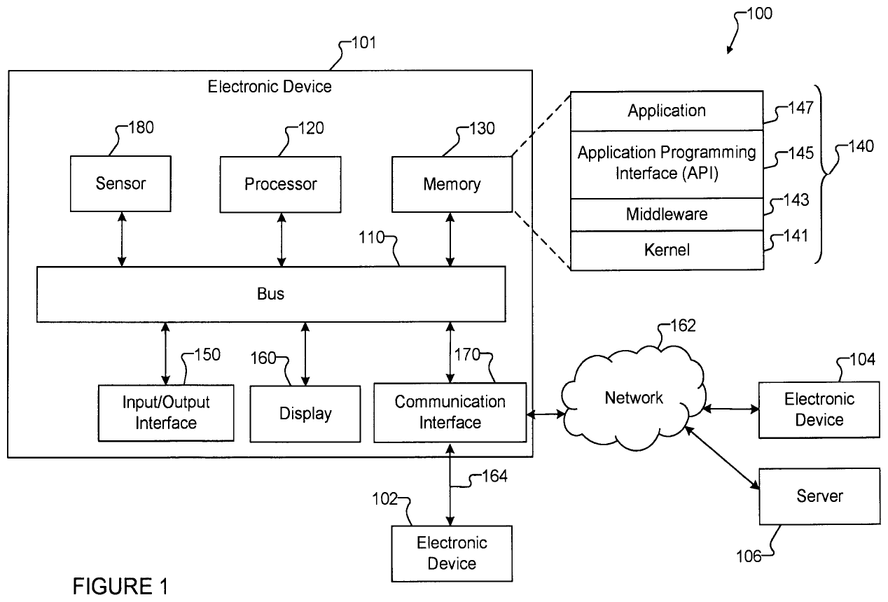

FIGS. 1 through 13, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

Many VST XR devices are adjustable to accommodate different inter-pupillary distances (IPDs). An inter-pupillary distance refers to the distance between the pupils of a user's eyes, and different users can have different inter-pupillary distances. As a result, making VST XR devices adjustable allows different users to use the VST XR devices without requiring customized designs for the VST XR devices. However, adjusting a VST XR device to support different inter-pupillary distances raises various issues. One issue is that a default inter-pupillary distance of a VST XR device is often aligned with see-through cameras of the VST XR device, where the see-through cameras are used to capture images of scenes around the VST XR device. Changing the inter-pupillary distance to accommodate the locations of a specific user's eyes generally causes misalignment between the actual locations of the see-through cameras and virtual camera locations, where the virtual camera locations represent the locations of the specific user's eyes (also known as eye viewpoints). Without corrective action, this can lead to the creation of parallax effects or other undesirable visual artifacts from the perspective of the user.

This disclosure provides various techniques supporting dynamic alignment between see-through cameras and eye viewpoints in VST XR. As described in more detail below, a determination can be made that an inter-pupillary distance between left and right display lenses of a VST XR device has been adjusted with respect to a default IPD of the VST XR device. An image can be captured using a see-through camera of the VST XR device, and the image can be transformed to match a viewpoint of a corresponding one of the display lenses according to a change in IPD with respect to the default IPD in order to generate a transformed image. Distortions in the transformed image can be corrected based on one or more lens distortion coefficients corresponding to the change in IPD in order to generate a corrected image, and the corrected image can be presented on a display panel of the VST XR device. This can be performed for images captured using different see-through cameras (such as left and right see-through cameras) to generate corrected images that are presented on one or more display panels (such as left and right display panels). This can also be repeated for any number of images. In some cases, this can involve dynamically matching a principal point of the see-through camera with a principal point of the display panel.

In this way, these techniques support the use of adjustable inter-pupillary distances in VST XR devices. In some cases, for example, the position or positions of one or more see-through cameras are fixed in a VST XR device, and the relative position(s) between the see-through camera(s) and one or more virtual cameras (one or more eyes of a user) can change when the inter-pupillary distance changes. The described techniques support remapping a see-through camera's perspective to a virtual camera's perspective based on this changed geometric relationship, and principal point matching (such as between the see-through camera viewpoint, display panel viewpoint, and eye viewpoint) can be performed. Moreover, different inter-pupillary distances can correspond to different distortions created by display lenses or other components of a VST XR device, and the described techniques support distortion compensation that can be based (at least partially) on the inter-pupillary distance being used. Among other things, the described techniques are able to dynamically align desired viewpoints and generate corrected final views of scenes for a user. With proper alignment, for instance, the user can view images in which virtual objects are properly aligned with real-world objects with parallax corrected.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dynamic alignment between see-through cameras and eye viewpoints in VST XR.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dynamic alignment between see-through cameras and eye viewpoints in VST XR. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram c (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dynamic alignment between see-through cameras and eye viewpoints in VST XR.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

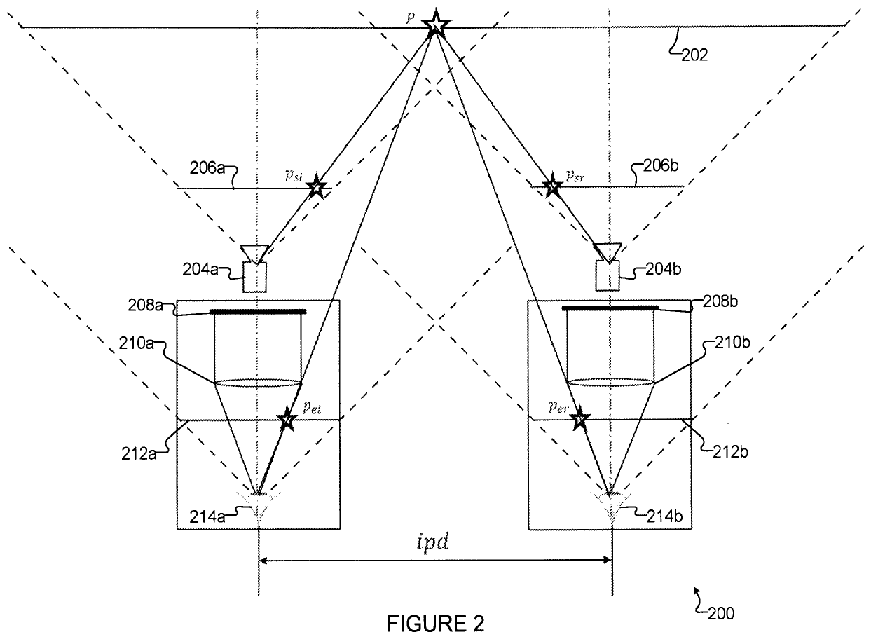

FIGS. 2 through 4 illustrate example arrangements of see-through cameras and eye viewpoints in VST XR in accordance with this disclosure. For ease of explanation, the arrangements shown in FIGS. 2 through 4 are described with respect to the electronic device 101 in the network configuration 100 of FIG. 1. However, the arrangements shown in FIGS. 2 through 4 may involve any other suitable device(s) and in any other suitable system(s).

As shown in FIGS. 2 through 4, a three-dimensional (3D) scene is being viewed by a user of the electronic device 101. In this example, the scene is represented using a plane 202, which is associated with a specific point P within the 3D scene. The electronic device 101 includes left and right see-through cameras 204a-204b, which can be used to capture images of the 3D scene. The see-through cameras 204a-204b may, for example, represent imaging sensors 180 of the electronic device 101. Each of the see-through cameras 204a-204b can be used to capture see-through image frames 206a-206b, respectively, which represent images that capture the 3D scene from the perspective of the see-through cameras 204a-204b.

The see-through image frames 206a-206b can be used to generate images that are presented on left and right display panels 208a-208b of the electronic device 101. The display panels 208a-208b may, for example, represent one or more displays 160 of the electronic device 101. In some cases, the display panels 208a-208b may represent separate displays 160. In other cases, the display panels 208a-208b may represent different portions of the same display 160. The images presented on the display panels 208a-208b are focused using left and right display lenses 210a-210b, which can represent convex-convex lenses or other suitable lenses used in the electronic device 101. The displayed images are used to create left and right virtual image frames 212a-212b, which can be viewed by left and right eyes 214a-214b of a user.

In the arrangement 200 shown in FIG. 2, a default distance between the user's left and right eyes 214a-214b (or between optical centers of the left and right display lenses 210a-210b) is referred to as a default inter-pupillary distance ipd. In some embodiments, the default inter-pupillary distance ipd may be about 63.5 millimeters, although other default inter-pupillary distances may be used. As shown in FIG. 2, the see-through camera 204a, display panel 208a, and display lens 210a are all aligned along a common optical axis on the left. Similarly, the see-through camera 204b, display panel 208b, and display lens 210b are all aligned along a common optical axis on the right. Because of this, the see-through camera's viewpoint, the eye's viewpoint, and the display panel's center on the left are aligned and on the right are aligned. As a result, each see-through image frame 206a-206b can be processed and rendered to the corresponding display panel 208a-208b, and each eye 214a-214b can view the rendered frame on the corresponding display panel 208a-208b through the corresponding display lens 210a-210b.

In the arrangement 200 of FIG. 2, the point P within the scene is projected to the left see-through camera 204a at point pₛₗ and to the left virtual camera (left eye 214a) at point pₑₗ. Since the left virtual camera cannot directly view the point P, the point pₛₗ on the left see-through image frame 206a is transformed to the point pₑₗ on the left virtual image frame 212a. Similarly, the point P within the scene is projected to the right see-through camera 204b at point pₛᵣ and to the right virtual camera (right eye 214b) at point pₑᵣ. Since the right virtual camera cannot directly view the point P, the point pₛᵣ on the right see-through image frame 206b is transformed to the point pₑᵣ on the right virtual image frame 212b.

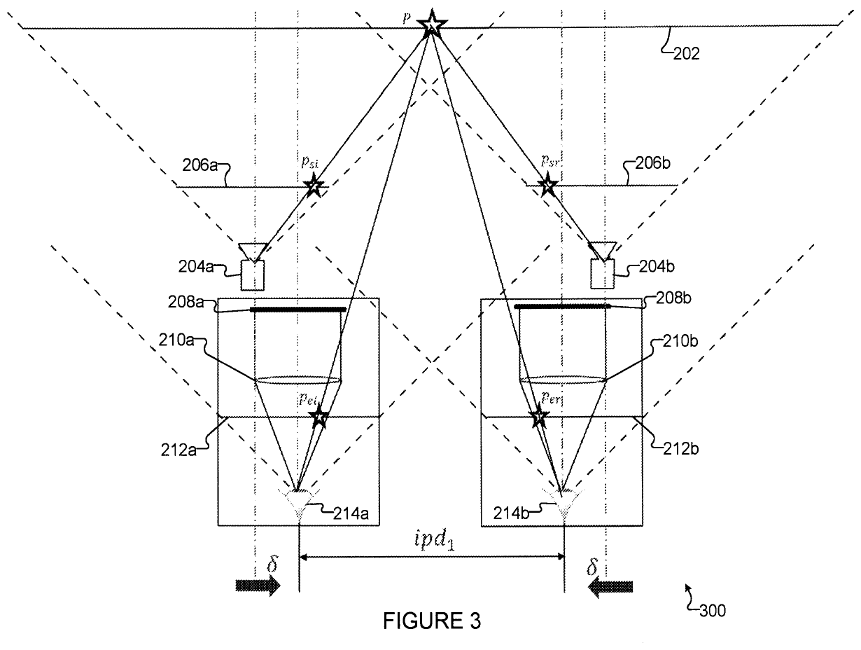

In the arrangement 300 shown in FIG. 3, the display panels 208a-208b and the display lenses 210a-210b have been moved inward, which reduces the distance between the user's left and right eyes 214a-214b and creates an inter-pupillary distance ipd₁. Here, the display panel 208a and the display lens 210a can move inward (to the left) by a distance δ, and the display panel 208b and the display lens 210b can move inward (to the right) by a distance δ. Thus, it can be said that ipd₁<ipd and that ipd₁ can range from ipd−2δ up to just below ipd.

As shown in FIG. 3, the see-through camera 204a is not aligned with the display panel 208a and the display lens 210a, meaning the optical axis of the see-through camera 204a is not the same as the optical axis of the display panel 208a and the display lens 210a. Similarly, the see-through camera 204b is not aligned with the display panel 208b and the display lens 210b, meaning the optical axis of the see-through camera 204b is not the same as the optical axis of the display panel 208b and the display lens 210b. Because of this, the see-through camera's viewpoint, the eye's viewpoint, and the display panel's center on the left are not aligned and on the right are not aligned. As a result, each see-through image frame 206a-206b can be transformed as described below and rendered to the corresponding display panel 208a-208b, and each eye 214a-214b can view the rendered frame on the corresponding display panel 208a-208b through the corresponding display lens 210a-210b.

In the arrangement 300 of FIG. 3, the point P within the scene is projected to the left see-through camera 204a at point pₛₗ and to the left virtual camera (left eye 214a) at point pₑₗ. Since the left virtual camera cannot directly view the point P, the point pₛₗ on the left see-through image frame 206a is transformed to the point pₑₗ on the left virtual image frame 212a. Similarly, the point P within the scene is projected to the right see-through camera 204b at point pₛᵣ and to the right virtual camera (right eye 214b) at point pₑᵣ. Since the right virtual camera cannot directly view the point P, the point pₑᵣ on the right see-through image frame 206b is transformed to the point pₑᵣ on the right virtual image frame 212b. Compared to the arrangement 200 shown in FIG. 2, however, the locations of the projected points pₑₗ on the left virtual image frame 212a and pₑᵣ on the right virtual image frame 212b have changed due to the geometric relationship changes, and a new transformation can be used to generate the left and right virtual views.

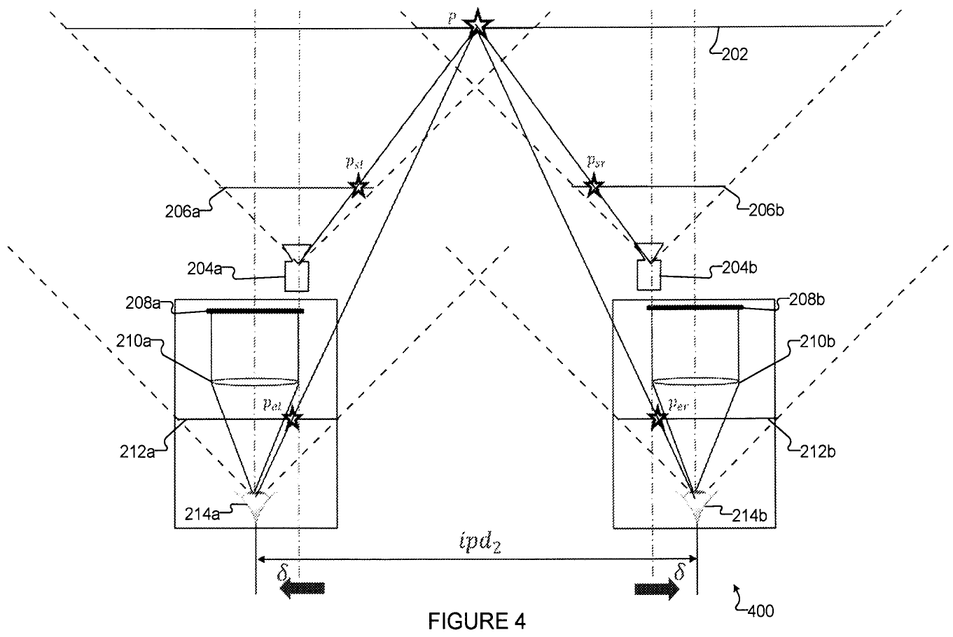

In the arrangement 400 shown in FIG. 4, the display panels 208a-208b and the display lenses 210a-210b have been moved outward, which increases the distance between the user's left and right eyes 214a-214b and creates an inter-pupillary distance ipd₂. Here, the display panel 208a and the display lens 210a can move outward (to the left) by a distance δ, and the display panel 208b and the display lens 210b can move outward (to the right) by a distance δ. Thus, it can be said that ipd<ipd₂ and that ipd₂ can range from just above ipd up to ipd+2δ.

As shown in FIG. 4, the see-through camera 204a is not aligned with the display panel 208a and the display lens 210a, meaning the optical axis of the see-through camera 204a is not the same as the optical axis of the display panel 208a and the display lens 210a. Similarly, the see-through camera 204b is not aligned with the display panel 208b and the display lens 210b, meaning the optical axis of the see-through camera 204b is not the same as the optical axis of the display panel 208b and the display lens 210b. Because of this, the see-through camera's viewpoint, the eye's viewpoint, and the display panel's center on the left are not aligned and on the right are not aligned. As a result, each see-through image frame 206a-206b can be transformed as described below and rendered to the corresponding display panel 208a-208b, and each eye 214a-214b can view the rendered frame on the corresponding display panel 208a-208b through the corresponding display lens 210a-210b.

In the arrangement 400 of FIG. 4, the point P within the scene is projected to the left see-through camera 204a at point pₛₗ and to the left virtual camera (left eye 214a) at point pₑₗ. Since the left virtual camera cannot directly view the point P, the point pₛₗ on the left see-through image frame 206a is transformed to the point pₑₗ on the left virtual image frame 212a. Similarly, the point P within the scene is projected to the right see-through camera 204b at point pₛᵣ and to the right virtual camera (right eye 214b) at point pₑᵣ. Since the right virtual camera cannot directly view the point P, the point pₛᵣ on the right see-through image frame 206b is transformed to the point pₑᵣ on the right virtual image frame 212b. Compared to the arrangement 200 shown in FIG. 2, however, the locations of the projected points pₑₗ on the left virtual image frame 212a and pₑᵣ on the right virtual image frame 212b have changed due to the geometric relationship changes, and a new transformation can be used to generate the left and right virtual views.

Based on this, the electronic device 101 can be configured to permit dynamic adjustment of the inter-pupillary distance within a range from ipd₁ to ipd₂, which can be expressed as [ipd−2δ, ipd+2δ]. Assuming the see-through cameras 204a-204b have fixed positions, adjusting the inter-pupillary distance to any value other than the default value ipd can create misalignment between the see-through cameras 204a-204b and the corresponding display panels 208a-208b and display lenses 212a-212b. The techniques described below can be used by the electronic device 101 to support remapping of image data to compensate for this lack of alignment when the inter-pupillary distance is dynamically adjusted away from the default ipd. For example, the projection points pₛₗ on the left see-through image frame 206a and pₛᵣ on the right see-through image frame 206b may not change as the inter-pupillary distance is adjusted. However, the projection points pₑₗ on the left virtual image frame 212a and pₑᵣ on the right virtual image frame 212b can change. The electronic device 101 can use the techniques described below to transform the point pₛₗ to the point pₑₗ and the point pₛᵣ to the point pₑᵣ dynamically based on the geometric relationship associated with the current value of the inter-pupillary distance.

The techniques described below can also be used to support adaptive geometric distortion and chromatic aberration models when the inter-pupillary distance is dynamically adjusted. Changes to the inter-pupillary distance can affect geometric distortions, chromatic aberrations, or other distortions created by the electronic device 101 to the images presented on the display panels 208a-208b. As a result, changing the inter-pupillary distance can alter how geometric distortions, chromatic aberrations, or other distortions are created, which thereby affects how distortion compensation is performed to reduce or eliminate those distortions. The electronic device 101 can use the techniques described below to adjust one or more models used to perform distortion compensation based on the geometric relationship associated with the current value of the inter-pupillary distance. Note that this may be particularly useful when each display panel 208a-208b is movable relative to its associated display lens 210a-210b, meaning each display panel 208a-208b and its corresponding display lens 210a-210b need not be fixed relative to one another.

Although FIGS. 2 through 4 illustrate examples of arrangements of sec-through cameras and eye viewpoints in VST XR, various changes may be made to FIGS. 2 through 4. For example, while it is assumed here that the inter-pupillary distance can range from ipd−2δ to ipd+2δ, there is no requirement that the range of inter-pupillary distance values needs to be symmetrical. As a particular example, the default inter-pupillary distance ipd may be closer to one end of the range of inter-pupillary distance values than to the other end of the range.

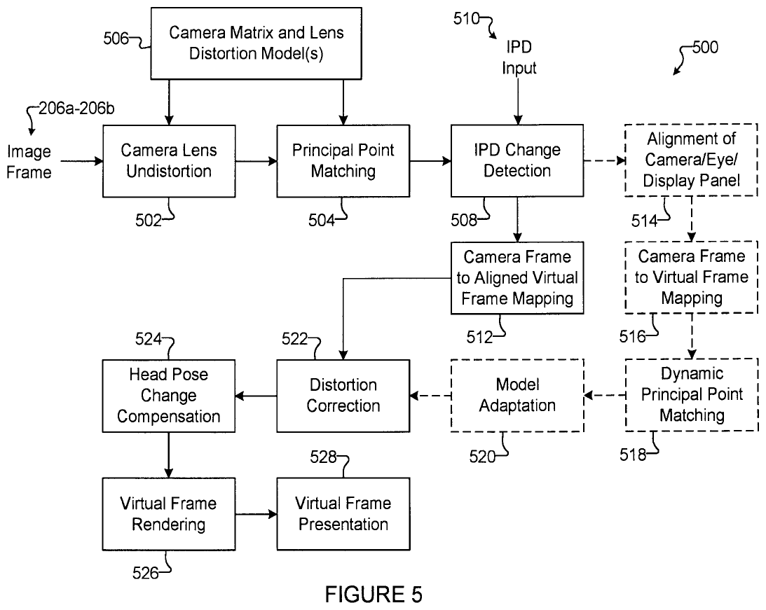

FIG. 5 illustrates an example architecture 500 supporting dynamic alignment between see-through cameras and eye viewpoints in VST XR in accordance with this disclosure. For case of explanation, the architecture 500 of FIG. 5 is described as being implemented using the electronic device 101 in the network configuration 100 of FIG. 1, where the architecture 500 may be used with any of the arrangements of components shown in FIGS. 2 through 4. However, the architecture 500 may be implemented using any other suitable device(s) and in any other suitable system(s), and the architecture 500 may be used with any other suitable arrangement(s) of components.

As shown in FIG. 5, the architecture 500 receives and processes a sec-through image frame 206a or 206b. As described above, the see-through image frame 206a or 206b is captured using one of the see-through cameras 204a or 204b. A camera lens undistortion operation 502 generally operates to pre-process the see-through image frame 206a or 206b in order to reduce camera lens distortion in the see-through image frame 206a or 206b. The camera lens undistortion operation 502 may reduce any suitable camera lens-based distortion from the see-through image frame 206a or 206b, such as radial or tangential distortion.

A principal point matching operation 504 generally operates to match the principal point of the see-through camera 204a or 204b with the center of the corresponding display panel 208a or 208b. For instance, the principal point matching operation 504 may identify the principal point of the see-through camera 204a or 204b and identify the center point of the corresponding display panel 208a or 208b, which allows the principal point matching operation 504 to indicate whether the see-through camera 204a or 204b and the corresponding display panel 208a or 208b are aligned.

In some embodiments, one or both of the camera lens undistortion operation 502 and the principal point matching operation 504 may operate using a see-through camera matrix and lens distortion model(s) 506, which represent camera calibration data or other data defining known characteristics of the electronic device 101. A camera matrix is often defined as a three-by-three matrix that includes two focal lengths in the x and y directions and the principal point of the camera defined using x and y coordinates. A lens distortion model is often defined as a mathematical model that indicates how images can be undistorted, which can be derived based on the specific lens or other optical component(s) being used. In some cases, multiple lens distortion models may be used, such as when one model is used to correct lens geometric distortions and another model is used to correct chromatic aberrations. Note that since the position of the see-through camera 204a or 204b and the camera calibration parameters are fixed, the principal point matching may be static and may only need to be performed once (regardless of how many see-through image frames 206a or 206b are captured using the current inter-pupillary distance of the electronic device 101).

An IPD change detection operation 508 generally operates to detect a change to the inter-pupillary distance of the electronic device 101, such as to a non-default inter-pupillary distance value (like a value other than ipd). In some cases, for instance, an IPD input 510 may represent an input from a sensor or other device that can sense or measure the current inter-pupillary distance of the electronic device 101. If the inter-pupillary distance of the electronic device 101 has not changed (such as when the current inter-pupillary distance of the electronic device 101 matches the default inter-pupillary distance ipd), the electronic device 101 may already know how to map the image frame 206a or 206b to a virtual image frame 212a or 212b. This is because it may be known that the see-through camera 204a or 204b is aligned with the corresponding display panel 208a or 208b. A camera frame-to-aligned virtual frame mapping operation 512 generally operates to map the image frame 206a or 206b into the corresponding virtual image frame 212a or 212b. Using FIG. 2 as an example, the camera frame-to-aligned virtual frame mapping operation 512 can map individual points pₛₗ or pₛᵣ from the image frame 206a or 206b into corresponding points pₑₗ or pₑᵣ in the corresponding virtual image frame 212a or 212b based on the known geometric relationship between the image frame 206a or 206b and the virtual image frame 212a or 212b (which is known due to the alignment of the see-through camera 204a or 204b and the corresponding display panel 208a or 208b). This can be done for all points in the image frame 206a or 206b.

If the inter-pupillary distance of the electronic device 101 has changed (such as when the current inter-pupillary distance of the electronic device 101 no longer matches the default inter-pupillary distance ipd), the electronic device 101 learns how to map the image frame 206a or 206b to a virtual image frame 212a or 212b. In this example, an alignment operation 514 generally operates to dynamically align the see-through camera's viewpoint, the eye's viewpoint, and the display panel's center in order to build geometric relationships between those points. Assumed here is that the display panel 208a or 208b and the associated display lens 210a or 210b have been moved inward or outward so that the current inter-pupillary distance of the electronic device 101 no longer matches the default inter-pupillary distance ipd. Given that, the alignment operation 514 can identify the current viewpoint of the sec-through camera 204a or 204b, the current viewpoint of the user's eye 214a or 214b, and the current location of the center of the display panel 208a or 208b.

A non-aligned camera frame-to-non-aligned virtual frame mapping operation 516 generally operates to map the image frame 206a or 206b to the corresponding virtual image frame 212a or 212b based on the now-learned geometric relationships between the current viewpoint of the see-through camera 204a or 204b, the current viewpoint of the user's eye 214a or 214b, and the current location of the center of the display panel 208a or 208b. Using FIG. 3 or FIG. 4 as an example, the non-aligned camera frame-to-non-aligned virtual frame mapping operation 516 can map individual points pₛₗ or pₛᵣ from the image frame 206a or 206b into corresponding points pₑₗ or pₑᵣ in the corresponding virtual image frame 212a or 212b based on the learned geometric relationship between the image frame 206a or 206b and the virtual image frame 212a or 212b. Again, this can be done for all points in the image frame 206a or 206b. This dynamically maps the non-aligned see-through image frame 206a or 206b to the non-aligned virtual image frame 212a or 212b by matching the different viewpoints and applying adjusted geometric relationships. Among other things, this helps to dynamically correct parallax errors while changing the inter-pupillary distance by mapping the see-through image frame 206a or 206b to the virtual image frame 212a or 212b.

A dynamic principal point matching operation 518 generally operates to dynamically match the principal point of the see-through camera 204a or 204b with the center of the display panel 208a or 208b. For instance, the dynamic principal point matching operation 518 may identify the principal point of the see-through camera 204a or 204b and identify the center point of the corresponding display panel 208a or 208b, which now can differ since the sec-through camera 204a or 204b and the corresponding display panel 208a or 208b are not aligned. The end result of this sequence of operations is the generation of a transformed image.

A model adaptation operation 520 generally operates to adjust the lens distortion model(s) to account for the now-misaligned nature of the various components in the electronic device 101. For example, the model adaptation operation 520 may adjust the model used to correct lens geometric distortions and the model used to correct chromatic aberrations. The model or models can be adjusted here based on the change to the inter-pupillary distance of the electronic device 101. For example, different inter-pupillary distances can have different parameters for lens distortion models and chromatic aberration models. Using the current value of the inter-pupillary distance allows the electronic device 101 to identify suitable models for correcting the virtual image frame 212a or 212b.

A distortion correction operation 522 generally operates to reduce or eliminate distortions in the virtual image frame 212a or 212b (the transformed image). For example, the distortion correction operation 522 can perform display lens geometric distortion correction and chromatic aberration correction with a proper distortion model based on the current inter-pupillary distance. Note that the distortion correction operation 522 can be performed regardless of the whether the virtual image frame 212a or 212b is generated using the camera frame-to-aligned virtual frame mapping operation 512 or the non-aligned camera frame-to-non-aligned virtual frame mapping operation 516. This results in the generation of a corrected image.

One or more post-processing operations may be performed using the corrected image. For example, a head pose change compensation operation 524 can be used to sense a change in head pose by a user who is using the electronic device 101. In some cases, this can be based on IMU sensor data or other sensor data generated by the electronic device 101. A change in the head pose can be used to adjust the corrected image, such as to adjust the corrected image for changes in the user's head pose that occur between when the image frame 206a or 206b was captured and when the resulting virtual image frame 212a or 212b is being rendered and presented. A virtual image frame rendering operation 526 generally operates to render the virtual image frame 212a or 212b (possibly as modified by the head pose change compensation operation 524). The virtual image frame rendering operation 526 generates a final image of the scene that can be presented to a user, such as on the corresponding display panel 208a-208b. A virtual image frame presentation operation 528 generally operates to initiate presentation of the rendered final image on the corresponding display panel 208a-208b, such as by providing suitable image data to the corresponding display panel 208a-208b.

Although FIG. 5 illustrates one example of an architecture 500 supporting dynamic alignment between see-through cameras and eye viewpoints in VST XR, various changes may be made to FIG. 5. For example, various components or functions in FIG. 5 may be combined, further subdivided, replicated, omitted, or rearranged and additional components or functions may be added according to particular needs. Also, note that the same process described above as being performed by the architecture 500 may be repeated for any number of see-through image frames 206a-206b. For instance, the architecture 500 may be used to repeatedly process see-through image frames 206a-206b captured using left and right see-through cameras 204a-204b for presentation of rendered images on the display panels 208a-208b.

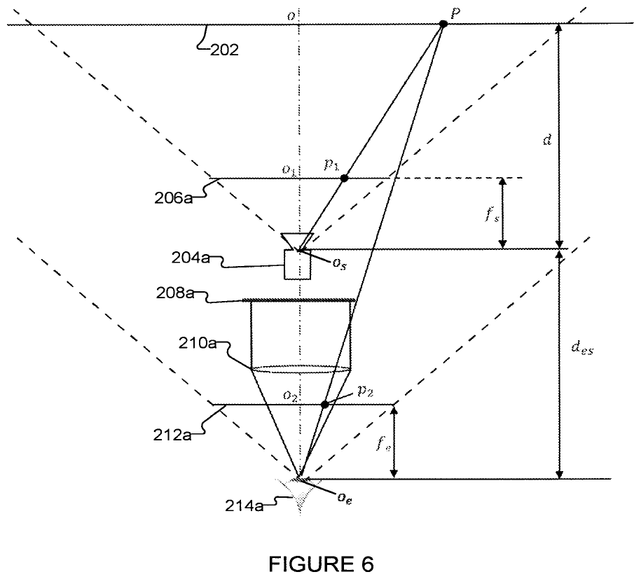

FIGS. 6 through 8 illustrate example dynamic alignments between see-through cameras and eye viewpoints in VST XR in accordance with this disclosure. For ease of explanation, the dynamic alignments shown in FIGS. 6 through 8 are described as being provided by the architecture 500 of FIG. 5, which may be implemented using the electronic device 101 in the network configuration 100 of FIG. 1. However, the architecture 500 may be used in any other suitable manner.

As described above, the alignment operation 514 generally operates to dynamically align a see-through camera's viewpoint, an eye's viewpoint, and a display panel's center in order to build geometric relationships between those points. Also, the non-aligned camera frame-to-non-aligned virtual frame mapping operation 516 generally operates to map a see-through image frame 206a or 206b to a corresponding virtual image frame 212a or 212b based on the geometric relationships between the current viewpoint of the see-through camera 204a or 204b, the current viewpoint of the user's eye 214a or 214b, and the current location of the center of the display panel 208a or 208b.

As shown in FIG. 6, the see-through camera 204a, the display panel 208a, and the display lens 210a are aligned such that a common optical axis passes through all three components. While not shown here, the see-through camera 204b, the display panel 208b, and the display lens 210b are also aligned. This is consistent with the arrangement 200 shown in FIG. 2. In this example, the point P in the 3D scene projects to a point p₁ in the see-through image frame 206a, where the point p₁ has coordinates (xₛ, yₛ). That point p₁ projects to a point p₂ in the virtual image frame 212a, where the point p₂ has coordinates (xₑ, yₑ). The center of the see-through camera's lens is denoted oₛ, and the center of the virtual camera at the user's eye 214a is denoted oₑ. The principal point of the see-through camera 204a is denoted o₁, and the principal point of the virtual camera is denoted o₂ (note that o₂=oₛ in the aligned configuration). A point o represents a point on the optical axis of the see-through camera 204a at the plane 202 of the 3D scene. The distance between the user's eye 214a and the imaging plane of the see-through camera 204a is denoted dₑₛ, and the depth of the point P is denoted d. The focal length of the user's eye 214a is denoted fₑ, and the focal length of the see-through camera 204a is denoted fₛ (in some cases, fₑ=fₛ=f).

In some embodiments, in order to map the see-through image frame 206a to the virtual image frame 212a in FIG. 6, it can be shown that:

$$\frac{{o}_{1} {p}_{1}}{oP} = \frac{{o}_{s} {o}_{1}}{{o}_{s} o} \qquad ( 1 )$$

$$\frac{{x}_{s}}{X} = \frac{f}{d} \qquad ( 2 )$$

Here, xₛ represents the x coordinate of p₁ (xₛ, yₛ), X represents the x coordinate of the 3D point P(X, Y, Z), f represents the focal length of the see-through camera 204a, and d represents the depth of the 3D point P(X, Y, Z). It can also be shown that:

$$\frac{{o}_{2} {p}_{2}}{oP} = \frac{{o}_{e} {o}_{2}}{{o}_{e} o} \qquad ( 3 )$$

$$\frac{{x}_{e}}{X} = \frac{f}{d + {d}_{es}} \qquad ( 4 )$$

Here, xₑ represents the x coordinate of p₂ (xₑ, yₑ), and dₑₛ represents the distance between the user's eye 214a and the imaging plane of the see-through camera 204a. By removing X in Equations (2) and (4), the following can be obtained.

$${x}_{e} = \frac{d}{d + {d}_{es}} {x}_{s} \qquad ( 5 )$$

After deriving a similar equation for yₑ, the following set of equations can be used to map the see-through image frame 206a to the virtual image frame 212a.

$$\{ \begin{matrix}{x}_{e} = \frac{d}{d + {d}_{es}} {x}_{s} \\ {y}_{e} = \frac{d}{d + {d}_{es}} {y}_{s}\end{matrix} \qquad ( 6 )$$

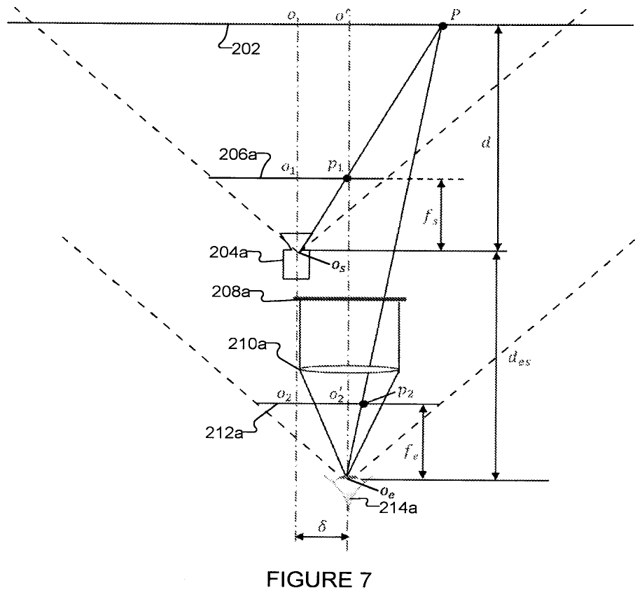

As shown in FIG. 7, the see-through camera 204a, the display panel 208a, and the display lens 210a are not aligned. Rather, the display panel 208a and the display lens 210a have been moved inward by a distance δ, so there is an optical axis o passing through the see-through camera 204a and an optical axis o′ passing through the display panel 208a and the display lens 210a. While not shown here, the see-through camera 204b, the display panel 208b, and the display lens 210b have the same arrangement, where the display panel 208b and the display lens 210b have been moved inward by a distance δ. This is consistent with the arrangement 300 shown in FIG. 3. The principal point of the virtual camera in its new position is denoted o₂′ (note that o₂≠oₛ in the non-aligned configuration). A point o′ represents a point on the optical axis of the virtual camera at the plane 202 of the 3D scene, which is now different than the point o.

In some embodiments, in order to map the see-through image frame 206a to the virtual image frame 212a in FIG. 7, it can be shown that:

$$\frac{{o}_{1} {p}_{1}}{oP} = \frac{{o}_{s} {o}_{1}}{{o}_{s} o} \qquad ( 7 )$$

$$\frac{{x}_{s}}{X} = \frac{f}{d} \qquad ( 8 )$$

These match Equations (1) and (2) above. It can also be shown that:

$$\frac{{o}_{2}^{′} {p}_{2}}{{o}^{′} P} = \frac{{o}_{e} {o}_{2}^{′}}{{o}_{e} {o}^{′}} \qquad ( 9 )$$

$$\frac{{x}_{e}}{X - δ} = \frac{f}{d + {d}_{es}} \qquad ( 10 )$$

By removing X in Equations (8) and (10), the following can be obtained.

$${x}_{e} = \frac{{dx}_{s} - f δ}{d + {d}_{es}} \qquad ( 11 )$$

After deriving a similar equation for yₑ, the following set of equations can be used to map the see-through image frame 206a to the virtual image frame 212a.

$$\{ \begin{matrix}{x}_{e} = \frac{{dx}_{s} - f δ}{d + {d}_{es}} \\ {y}_{e} = \frac{{dy}_{s} - f δ}{d + {d}_{es}}\end{matrix} \qquad ( 12 )$$

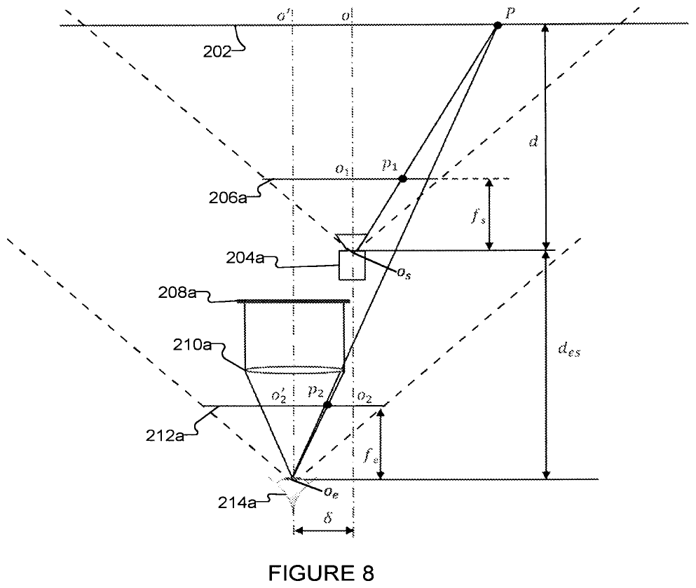

As shown in FIG. 8, the see-through camera 204a, the display panel 208a, and the display lens 210a are not aligned. Rather, the display panel 208a and the display lens 210a have been moved outward by a distance δ, so there is an optical axis o passing through the see-through camera 204a and an optical axis o′ passing through the display panel 208a and the display lens 210a. While not shown here, the see-through camera 204b, the display panel 208b, and the display lens 210b have the same arrangement, where the display panel 208b and the display lens 210b have been moved outward by a distance δ. This is consistent with the arrangement 400 shown in FIG. 4.

In some embodiments, in order to map the see-through image frame 206a to the virtual image frame 212a in FIG. 8, it can be shown that:

$$\frac{{o}_{1} {p}_{1}}{o P} = \frac{{o}_{s} {o}_{1}}{{o}_{s} o} \qquad ( 13 )$$

$$\frac{{x}_{s}}{X} = \frac{f}{d} \qquad ( 14 )$$

These match Equations (1) and (2) above. It can also be shown that:

$$\frac{{o}_{2}^{′} {p}_{2}}{{o}^{′} P} = \frac{{o}_{e} {o}_{2}^{′}}{{o}_{e} {o}^{′}} \qquad ( 15 )$$

$$\frac{{x}_{e}}{X + δ} = \frac{f}{d + {d}_{e s}} \qquad ( 16 )$$

By removing X in Equations (14) and (16), the following can be obtained.

$${x}_{e} = \frac{d {x}_{s} + f δ}{d + {d}_{e s}} \qquad ( 17 )$$

After deriving a similar equation for yₑ, the following set of equations can be used to map the see-through image frame 206a to the virtual image frame 212a.

$$\{ \begin{matrix}{x}_{e} = \frac{{dx}_{s} + f δ}{d + {d}_{es}} \\ {y}_{e} = \frac{{dy}_{s} + f δ}{d + {d}_{es}}\end{matrix} \qquad ( 18 )$$

As can be seen here, Equations (6), (12), and (18) provide a way to transform a see-through image frame 206a to match the viewpoint of a corresponding display lens 210a. This mapping can be achieved regardless of whether the current inter-pupillary distance matches a default inter-pupillary distance, is smaller than the default inter-pupillary distance by 2δ, or is larger than the default inter-pupillary distance by 2δ. Thus, the alignment operation 514 and the non-aligned camera frame-to-non-aligned virtual frame mapping operation 516 are able to align viewpoints dynamically in the presence of changing inter-pupillary distances.

Although FIGS. 6 through 8 illustrate examples of dynamic alignments between see-through cameras and eye viewpoints in VST XR, various changes may be made to FIGS. 6 through 8. For example, the same or similar processes described with reference to FIGS. 6 through 8 may occur for the components associated with the user's right eye 214b. Also, while it is assumed here that each display panel 208a-208b is fixed relative to its associated display lens 210a-210b, other embodiments may allow each display panel 208a-208b to be movable relative to its associated display lens 210a-210b.

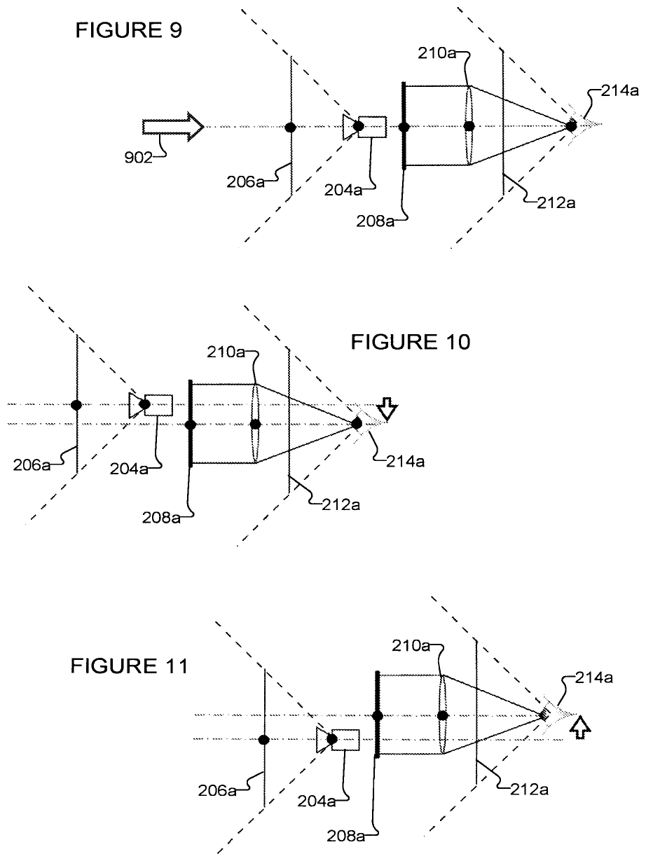

FIGS. 9 through 11 illustrate example arrangements of principal points associated with VST XR in accordance with this disclosure. For ease of explanation, the arrangements shown in FIGS. 9 through 11 are described with respect to the electronic device 101 in the network configuration 100 of FIG. 1. However, the arrangements shown in FIGS. 9 through 11 may involve any other suitable device(s) and in any other suitable system(s).

As described above, the dynamic principal point matching operation 518 generally operates to dynamically match the principal point of the see-through camera 204a or 204b with the center of the display panel 208a or 208b. As shown in FIG. 9, a point is identified for each of the see-through camera 204a, see-through image frame 206a, display panel 208a, display lens 210a, and user eye 214a. Incoming illumination 902 is received from the scene and used by the see-through camera 204a to generate the see-through image frame 206a. The identified point of the see-through camera 204a can represent the principal point of the see-through camera 204a, where the principal point of the see-through camera 204a refers to the location where an optical axis intersects the image plane of the see-through camera 204a. The identified point of the display panel 208a can represent the center of the display panel 208a. The identified point of the eye 214a can represent the viewpoint of the user's eye 214a. While not shown here, the same arrangement of elements can be associated with the user's right eye 214b.

In the example shown in FIG. 9, the various points are aligned, indicating that the arrangement 200 shown in FIG. 2 is currently in use. Because of that, the sec-through camera's principal point, the eye's viewpoint, and the display panel's center are aligned, which typically occurs when the inter-pupillary distance being used matches the default inter-pupillary distance ipd. As a result, the see-through image frame 206a can be mapped to the virtual image frame 212a with an aligned geometric relationship for parallax correction. The virtual image frame 212a can be rendered and displayed on the corresponding display panel 208a, and the user can obtain a correct view through the corresponding display lens 210a.

As shown in FIGS. 10 and 11, the various points are no longer aligned, indicating that the arrangement 300 shown in FIG. 3 or the arrangement 400 shown in FIG. 4 is currently in use. Because of that, the geometric relationships between the see-through camera's principal point, the eye's viewpoint, and the display panel's center have changed. As a result, in order to map the see-through image frame 206a to the virtual image frame 212a, the see-through camera's principal point is matched with the eye's viewpoint and the display panel's center. Moreover, distortion correction can be performed as described below based on the change to the inter-pupillary distance relative to the default inter-pupillary distance ipd.

When the principal point of the see-through camera 204a and the center of the display panel 208a do not match, the see-through image frame 206a can be transformed by moving the principal point of the see-through camera 204a to the center of the virtual image frame 212a. In some embodiments, this can be accomplished using a camera matrix. One example of a camera matrix is as follows.

$$K = [ \begin{matrix}{f}_{x} & 0 & {c}_{x} \\ 0 & {f}_{y} & {c}_{y} \\ 0 & 0 & 1\end{matrix} ] \qquad ( 19 )$$

Here, (fₓ, f_{y}) represents the focal length of the see-through camera 204a in the x and y directions, and (cₓ, c_{y}) represents the principal point of the see-through camera 204a. In some cases, the camera matrix can be obtained by camera calibration. After mapping, the virtual image frame 212a can be rendered and displayed on the corresponding display panel 208a, and the user can obtain a correct view through the corresponding display lens 210a. In the example shown in FIG. 10, it can be shown that ipd₁=ipd−2δ as noted above with reference to FIG. 3. In the example shown in FIG. 11, it can be shown that ipd₁=ipd+2δ as noted above with reference to FIG. 4. In either case, the appropriate geometric relationship based on the decreased or increased inter-pupillary distance can be identified, and see-through image frames 206a can be mapped to virtual image frames 212a. The same type of process can be used to map see-through image frames 206b can be mapped to virtual image frames 212b.

Although FIGS. 9 through 11 illustrate examples of arrangements of principal points associated with VST XR, various changes may be made to FIGS. 9 through 11. For example, while it is assumed here that the inter-pupillary distance can range from ipd−2δ to ipd+2δ, there is no requirement that the range of inter-pupillary distance values needs to be symmetrical.

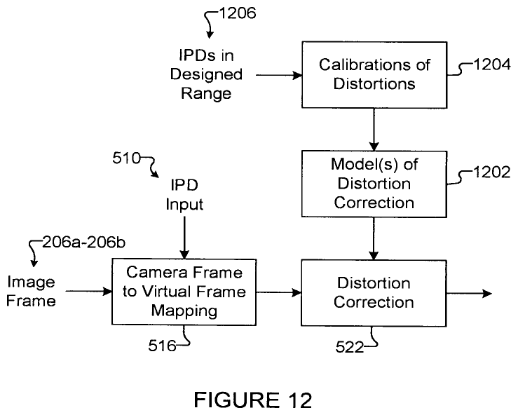

FIG. 12 illustrates an example architecture 1200 supporting dynamic distortion correction in VST XR in accordance with this disclosure. For ease of explanation, the architecture 1200 of FIG. 12 is described as being implemented using the electronic device 101 in the network configuration 100 of FIG. 1. However, the architecture 1200 may be implemented using any other suitable device(s) and in any other suitable system(s).

As shown in FIG. 12, the architecture 1200 includes or is used in conjunction with various operations of FIG. 5. Thus, the architecture 1200 may be used as a part of or with the architecture 500. In this example, a see-through image frame 206a or 206b can be mapped using the non-aligned camera frame-to-non-aligned virtual frame mapping operation 516, and the distortion correction operation 522 can reduce or eliminate distortions in a virtual image frame 212a or 212b. Other elements from FIG. 5 are omitted from FIG. 12 for brevity.

As part of the distortion correction operation 522, one or more models 1202 can be applied to the virtual image frame 212a or 212b in order to generate a corrected image. The one or more models 1202 may be used to correct any suitable distortions contained in the virtual image frame 212a or 212b, such as lens geometric distortions and/or chromatic aberrations. In some cases, separate models 1202 may be used to correct for lens geometric distortions and chromatic aberrations.

The model(s) 1202 used for distortion correction here can be adapted by the model adaptation operation 520 in order to account for the current inter-pupillary distance being used by the electronic device 101. For example, in some cases, the model(s) 1202 can include different parameters that are applied when different inter-pupillary distances are used, and the model adaptation operation 520 can select the appropriate parameters based on the current inter-pupillary distance. In some cases, the parameters of the models(s) 1202 can be determined for different inter-pupillary distances using known calibrations of distortions 1204, which can represent calibration data associated with lens geometric distortions, chromatic aberrations, or other distortions for different inter-pupillary distances within a designed range 1206 of IPDs. Thus, the model(s) 1202 can have different parameters for correcting distortions associated with different inter-pupillary distances.

As a particular example of this, a display lens distortion model may be expressed as follows.

$$\{ \begin{matrix}x = {x}_{e} ( {k}_{0} + {k}_{1} r + {k}_{2} {r}^{2} + {k}_{3} {r}^{3} + … + {k}_{n} {r}^{n} ) \\ y = {y}_{e} ( {k}_{0} + {k}_{1} r + {k}_{2} {r}^{2} + {k}_{3} {r}^{3} + … + {k}_{n} {r}^{n} )\end{matrix} \qquad ( 20 )$$

Here, (k₀, k₁, k₂, k₃, . . . kₙ) represent one or more lens distortion coefficients, x and y represent coordinates on the corresponding display panel, and r=\sqrt{xₑ²+yₑ²}. Different inter-pupillary distances can correspond to different distortion coefficients, which in some cases may be obtained frame display lens calibrations. As a result, the values of the lens distortion coefficient(s) (k₀, k₁, k₂, k₃, . . . kₙ) can be selected based on the current inter-pupillary distance being used. Once corrected, a final image of the scene can be presented to the user. Different users having different inter-pupillary distances can thereby receive substantially the same view based on use of a suitable mapping and suitable distortion correction.

Although FIG. 12 illustrates an example architecture 1200 supporting dynamic distortion correction in VST XR, various changes may be made to FIG. 12. For example, various components or functions in FIG. 12 may be combined, further subdivided, replicated, omitted, or rearranged and additional components or functions may be added according to particular needs. Also, note that the same process described above as being performed by the architecture 1200 may be repeated for any number of see-through image frames 206a-206b. For instance, the architecture 1200 may be used to repeatedly process see-through image frames 206a-206b captured using left and right see-through cameras 204a-204b for presentation of rendered images on the display panels 208a-208b.

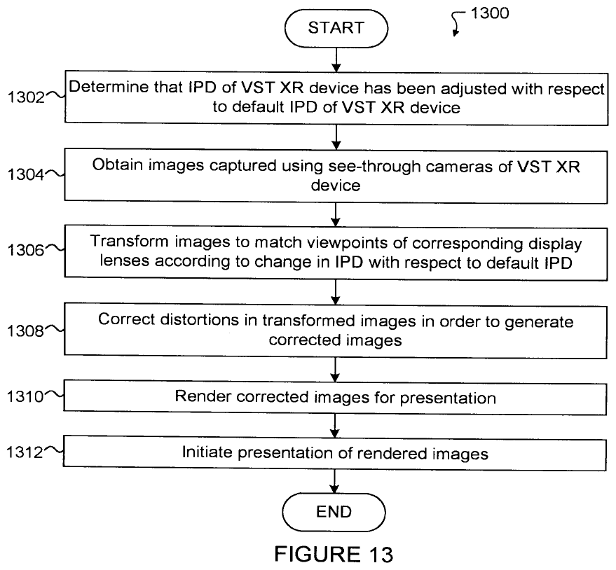

FIG. 13 illustrates an example method 1300 for dynamic alignment between see-through cameras and eye viewpoints in VST XR in accordance with this disclosure. For case of explanation, the method 1300 shown in FIG. 13 is described as being performed by the electronic device 101 in the network configuration 100 of FIG. 1, where the electronic device 101 can use the architectures 500 and 1200 shown in FIGS. 5 and 12. However, the method 1300 shown in FIG. 13 could be performed using any other suitable device(s) and architecture(s) and in any other suitable system(s).

As shown in FIG. 13, a determination is made that an inter-pupillary distance between left and right display lenses of a VST XR device has been adjusted with respect to a default IPD of the VST XR device at step 1302. In some embodiments, a user may adjust the inter-pupillary distance manually by interacting with a user control element (such as a physical button on the VST XR device or a virtual control panel displayed on the VST XR device) to improve alignment between the user's eyes and display panels of the VST XR device. In other embodiments, a camera or other sensor of the VST XR device may be used to capture an image of the user's eyes, and the image may be used to determine the position of the user's eyes. Based on the determined position, the inter-pupillary distance may be automatically adjusted for the user. Responsive to the inter-pupillary distance getting adjusted, the processor 120 of the electronic device 101 may receive sensor input or other input indicating that the inter-pupillary distance between the left and right display lenses 210a-210b has been adjusted and is no longer at a default inter-pupillary distance ipd. The input may be expressed in any suitable manner, such as a change in distance of the inter-pupillary distance relative to the default inter-pupillary distance ipd or a setting associated with a known change in distance.

One or more images are captured using one or more see-through cameras of the VST XR device at step 1304. This may include, for example, the processor 120 of the electronic device 101 obtaining one or more see-through image frames 206a-206 captured using one or more see-through cameras 204a-204b of the electronic device 101. In some cases, this may include obtaining one or more left see-through image frames 206a captured using the left sec-through camera 204a and one or more right see-through image frames 206b captured using the right see-through camera 204b. Each see-through image frame 206a-206b can represent a captured image of a 3D scene, such as the scene around a user/electronic device 101. Each see-through image frame 206a-206b may optionally be pre-processed, such as by performing the operation 502.

Each image is transformed to match the viewpoint of a corresponding display lens according to the change in the inter-pupillary distance with respect to the default inter-pupillary distance at step 1306. This may include, for example, the processor 120 of the electronic device 101 performing the operations 514, 516, 518 to transform each see-through image frame 206a-206b into a corresponding virtual image frame 212a-212b. In some embodiments, this can involve using Equation (12) to perform the mapping if the inter-pupillary distance is smaller than the default inter-pupillary distance or Equation (18) to perform the mapping if the inter-pupillary distance is larger than the default inter-pupillary distance. Among other things, this mapping can help to dynamically correct for parallax errors. Part of the transformation here can involve dynamically matching a principal point of each see-through camera 204a-204b with a principal point (center) of the corresponding display panel 208a-208b. This can result in the generation of one or more transformed images.

Distortions in the one or more transformed images can be at least partially corrected in order to generate one or more corrected images at step 1308. This may include, for example, the processor 120 of the electronic device 101 performing the operations 520, 522 to use one or more models 1202 for correcting lens geometric distortions and/or chromatic aberrations, where the corrections can be based on the change in the inter-pupillary distance with respect to the default inter-pupillary distance. In some embodiments, this can involve using Equation (20) to perform the distortion correction. Thus, for instance, one or more display lens geometric distortion and chromatic aberration models 1202 can be dynamically adapted based on the change in inter-pupillary distance, and the one or more adapted display lens geometric distortion and chromatic aberration models 1202 can be used to correct for display lens geometric distortions and chromatics aberrations.

Each corrected image can be rendered at step 1310, and presentation of each rendered image can be initiated at step 1312. This may include, for example, the processor 120 of the electronic device 101 performing the operations 526, 528 (possibly preceded by the operation 524) to generate one or more rendered images that can be presented on one or more appropriate display panels 208a-208b. As described above, a corrected image can be rendered and presented on the left display panel 208a associated with the left eye 214a of the user when the associated see-through image frame 206a is captured using the left see-through camera 204a, and a corrected image can be rendered and presented on the right display panel 208b associated with the right eye 214b of the user when the associated see-through image frame 206b is captured using the right see-through camera 204b.

Although FIG. 13 illustrates one example of a method 1300 for dynamic alignment between see-through cameras and eye viewpoints in VST XR, various changes may be made to FIG. 13. For example, while shown as a series of steps, various steps in FIG. 13 may overlap, occur in parallel, occur in a different order, or occur any number of times (including zero times).

It should be noted that the see-through cameras 204a-204b are often assumed above to be pointing forward, and this orientation of the see-through cameras 204a-204b is illustrated in various figures. However, this need not be the case, and other orientations of the see-through cameras 204a-204b may be used. For instance, the see-through cameras 204a-204b may be angled outward to provide a wider field of view. As long as the geometric relationship between each see-through camera 204a-204b and its associated display panel 208a-208b is known, the see-through image frames 206a-206b can be mapped to the virtual image frames 212a-212b.

It should also be noted that the display panels 208a-208b and their display lenses 210a-210b need not have a fixed relationship. As repeatedly noted above, each display panel 208a-208b and its corresponding display lens 210a-210b need not be fixed relative to one another. This can be accommodated by creating a mapping between each see-through camera and its associated virtual camera and between the virtual camera and the associated display panel.

It should further be noted that the functions shown in or described with respect to FIGS. 2 through 13 can be implemented in an electronic device 101, 102, 104, server 106, or other device(s) in any suitable manner. For example, in some embodiments, at least some of the functions shown in or described with respect to FIGS. 2 through 13 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 13 can be implemented or supported using dedicated hardware components. In general, the functions shown in or described with respect to FIGS. 2 through 13 can be performed using any suitable hardware or any suitable combination of hardware and software/firmware instructions. Also, the functions shown in or described with respect to FIGS. 2 through 13 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
determining, using at least one processing device, that an inter-pupillary distance (IPD) between left and right display lenses of a video see-through (VST) extended reality (XR) device has been adjusted with respect to a default IPD of the VST XR device;
obtaining, using the at least one processing device, an image captured using a see-through camera of the VST XR device, the see-through camera configured to capture images of a three-dimensional (3D) scene;
transforming, using the at least one processing device, the image to match a viewpoint of a corresponding one of the display lenses according to a change in IPD with respect to the default IPD in order to generate a transformed image;
correcting, using the at least one processing device, distortions in the transformed image based on one or more lens distortion coefficients corresponding to the change in IPD in order to generate a corrected image; and
initiating, using the at least one processing device, presentation of the corrected image on a display panel of the VST XR device.

2. The method of claim 1, wherein:
the corrected image is presented on a left display panel associated with a left eye of a user when the image is captured using a left see-through camera; and
the corrected image is presented on a right display panel associated with a right eye of the user when the image is captured using a right see-through camera.

3. The method of claim 1, wherein:
the see-through camera represents a left see-through camera;
the viewpoint corresponds to the left display lens;
the display panel represents a left display panel associated with a left eye of a user; and
the method further comprises:
obtaining, using the at least one processing device, a second image captured using a right see-through camera of the VST XR device;
transforming, using the at least one processing device, the second image to match a viewpoint of the right display lens in order to generate a second transformed image;
correcting, using the at least one processing device, distortions in the second transformed image in order to generate a second corrected image; and
initiating, using the at least one processing device, presentation of the second corrected image on a right display panel of the VST XR device, the right display panel associated with a right eye of the user.

4. The method of claim 1, wherein:
the IPD is adjusted to be smaller than the default IPD by 2δ; and
the image is transformed to match the viewpoint of the corresponding one of the display lenses using a formula of:
$$\{ \begin{matrix}{x}_{e} = \frac{{dx}_{s} - f δ}{d + {d}_{es}} \\ {y}_{e} = \frac{{dy}_{s} - f δ}{d + {d}_{es}}\end{matrix}$$
where xₛ and yₛ represent coordinates of a point of the image associated with a point in the 3D scene, xₑ and yₑ represent coordinates of the point projected onto the display panel, d represents a distance between the point in the 3D scene and the see-through camera, f represents a focal length of the see-through camera, and dₑₛ represents a distance between an eye of a user and the see-through camera.

5. The method of claim 1, wherein:
the IPD is adjusted to be larger than the default IPD by 2δ; and
the image is transformed to match the viewpoint of the corresponding one of the display lenses using a formula of:
$$\{ \begin{matrix}{x}_{e} = \frac{{dx}_{s} + f δ}{d + {d}_{es}} \\ {y}_{e} = \frac{{dy}_{s} + f δ}{d + {d}_{es}}\end{matrix}$$
where xₛ and yₛ represent coordinates of a point of the image associated with a point in the 3D scene, xₑ and yₑ represent coordinates of the point projected onto the display panel, d represents a distance between the point in the 3D scene and the see-through camera, f represents a focal length of the see-through camera, and dₑₛ represents a distance between an eye of a user and the see-through camera.

6. The method of claim 1, wherein correcting the distortions in the transformed image is performed using formulas of:
$$\{ \begin{matrix}x = {x}_{e} ( {k}_{0} + {k}_{1} r + {k}_{2} {r}^{2} + {k}_{3} {r}^{3} + … + {k}_{n} {r}^{n} ) \\ y = {y}_{e} ( {k}_{0} + {k}_{1} r + {k}_{2} {r}^{2} + {k}_{3} {r}^{3} + … + {k}_{n} {r}^{n} )\end{matrix}$$
where (k₀, k₁, k₂, k₃, . . . kₙ) represent the one or more lens distortion coefficients, x and y represent coordinates on the display panel, and r=\sqrt{xₑ²+yₑ²}.

7. The method of claim 1, wherein:
the display panel and the corresponding one of the display lenses are associated with one eye of a user; and
transforming the image to match the viewpoint of the corresponding one of the display lenses comprises dynamically matching a principal point of the see-through camera with a principal point of the display panel.

8. The method of claim 1, wherein transforming the image to match the viewpoint of the corresponding one of the display lenses comprises mapping a see-through camera frame to a virtual camera frame in order to dynamically correct for parallax errors.

9. The method of claim 1, wherein:
the display panel and the corresponding one of the display lenses are associated with one eye of a user; and
correcting the distortions in the transformed image comprises:
dynamically adapting one or more display lens geometric distortion and chromatic aberration models based on the change in IPD; and
using the one or more adapted display lens geometric distortion and chromatic aberration models to correct for display lens geometric distortions and chromatics aberrations.

10. A video see-through (VST) extended reality (XR) device comprising:
left and right see-through cameras configured to capture images of a three-dimensional (3D) scene;
a display panel configured to present virtual images;
left and right display lenses; and
at least one processing device configured to:
determine that an inter-pupillary distance (IPD) between the left and right display lenses has been adjusted with respect to a default IPD of the VST XR device;
obtain a specified one of the images captured using a specified one of the see-through cameras;
transform the specified image to match a viewpoint of a corresponding one of the display lenses according to a change in IPD with respect to the default IPD in order to generate a transformed image;
correct distortions in the transformed image based on one or more lens distortion coefficients corresponding to the change in IPD in order to generate a corrected image; and
initiate presentation of the corrected image on the display panel.

11. The VST XR device of claim 10, wherein the at least one processing device is configured to:
initiate presentation of the corrected image on a left display panel associated with a left eye of a user when the specified image is captured using the left see-through camera; and
initiate presentation of the corrected image on a right display panel associated with a right eye of the user when the specified image is captured using the right see-through camera.

12. The VST XR device of claim 10, wherein:
the specified see-through camera represents the left see-through camera;
the viewpoint corresponds to the left display lens;
the display panel represents a left display panel associated with a left eye of a user; and
the at least one processing device is further configured to:
obtain a second image captured using the right see-through camera;
transform the second image to match a viewpoint of the right display lens in order to generate a second transformed image;
correct distortions in the second transformed image in order to generate a second corrected image; and
initiate presentation of the second corrected image on a right display panel of the VST XR device, the right display panel associated with a right eye of the user.

13. The VST XR device of claim 10, wherein, when the IPD is adjusted to be smaller than the default IPD by 2δ, the at least one processing device is configured to transform the image to match the viewpoint of the corresponding one of the display lenses using a formula of:
$$\{ \begin{matrix}{x}_{e} = \frac{{dx}_{s} - f δ}{d + {d}_{es}} \\ {y}_{e} = \frac{{dy}_{s} - f δ}{d + {d}_{es}}\end{matrix}$$
where xₛ and yₛ represent coordinates of a point of the image associated with a point in the 3D scene, xₑ and yₑ represent coordinates of the point projected onto the display panel, d represents a distance between the point in the 3D scene and the see-through camera, f represents a focal length of the see-through camera, and dₑₛ represents a distance between an eye of a user and the see-through camera.

14. The VST XR device of claim 10, wherein, when the IPD is adjusted to be larger than the default IPD by 2δ, the at least one processing device is configured to transform the image to match the viewpoint of the corresponding one of the display lenses using a formula of:
$$\{ \begin{matrix}{x}_{e} = \frac{{dx}_{s} + f δ}{d + {d}_{es}} \\ {y}_{e} = \frac{{dy}_{s} + f δ}{d + {d}_{es}}\end{matrix}$$
where xₛ and yₛ represent coordinates of a point of the image associated with a point in the 3D scene, xₑ and yₑ represent coordinates of the point projected onto the display panel, d represents a distance between the point in the 3D scene and the see-through camera, f represents a focal length of the see-through camera, and dₑₛ represents a distance between an eye of a user and the see-through camera.

15. The VST XR device of claim 10, wherein, to correct the distortions in the transformed image, the at least one processing device is configured to use formulas of:
$$\{ \begin{matrix}x = {x}_{e} ( {k}_{0} + {k}_{1} r + {k}_{2} {r}^{2} + {k}_{3} {r}^{3} + … + {k}_{n} {r}^{n} ) \\ y = {y}_{e} ( {k}_{0} + {k}_{1} r + {k}_{2} {r}^{2} + {k}_{3} {r}^{3} + … + {k}_{n} {r}^{n} )\end{matrix}$$
where (k₀, k₁, k₂, k₃, . . . kₙ) represent the one or more lens distortion coefficients, x and y represent coordinates on the display panel, and r=\sqrt{xₑ²+yₑ²}.

16. The VST XR device of claim 10, wherein, to transform the image to match the viewpoint of the corresponding one of the display lenses, the at least one processing device is configured to dynamically match a principal point of the see-through camera with a principal point of the display panel.

17. The VST XR device of claim 10, wherein:
the display panel and the corresponding one of the display lenses are associated with one eye of a user; and
to correct the distortions in the transformed image, the at least one processing device is configured to:
dynamically adapt one or more display lens geometric distortion and chromatic aberration models based on the change in IPD; and
use the one or more adapted display lens geometric distortion and chromatic aberration models to correct for display lens geometric distortions and chromatics aberrations.

18. A non-transitory machine readable medium containing instructions that when executed cause at least one processor of a video see-through (VST) extended reality (XR) device to:
determine that an inter-pupillary distance (IPD) between left and right display lenses of the VST XR device has been adjusted with respect to a default IPD of the VST XR device;
obtain an image captured using a see-through camera of the VST XR device, the see-through camera configured to capture images of a three-dimensional (3D) scene;
transform the image to match a viewpoint of a corresponding one of the display lenses according to a change in IPD with respect to the default IPD in order to generate a transformed image;
correct distortions in the transformed image based on one or more lens distortion coefficients corresponding to the change in IPD in order to generate a corrected image; and
initiate presentation of the corrected image on a display panel of the VST XR device.

19. The non-transitory machine readable medium of claim 18, wherein the instructions that when executed cause the at least one processor to transform the image to match the viewpoint of the corresponding one of the display lenses comprise at least one of:
instructions that when executed cause the at least one processor, when the IPD is adjusted to be smaller than the default IPD by 2δ, to transform the image to match the viewpoint of the corresponding one of the display lenses using a formula of:
$$\{ \begin{matrix}{x}_{e} = \frac{{dx}_{s} - f δ}{d + {d}_{es}} \\ {y}_{e} = \frac{{dy}_{s} - f δ}{d + {d}_{es}}\end{matrix}$$
instructions that when executed cause the at least one processor, when the IPD is adjusted to be larger than the default IPD by 2δ, to transform the image to match the viewpoint of the corresponding one of the display lenses using a formula of:
$$\{ \begin{matrix}{x}_{e} = \frac{{dx}_{s} + f δ}{d + {d}_{es}} \\ {y}_{e} = \frac{{dy}_{s} + f δ}{d + {d}_{es}}\end{matrix}$$
where xₛ and yₛ represent coordinates of a point of the image associated with a point in the 3D scene, xₑ and yₑ represent coordinates of the point projected onto the display panel, d represents a distance between the point in the 3D scene and the see-through camera, f represents a focal length of the see-through camera, and dₑₛ represents a distance between an eye of a user and the see-through camera.

20. The non-transitory machine readable medium of claim 18, wherein the instructions that when executed cause the at least one processor to correct the distortions in the transformed image comprise:
instructions that when executed cause the at least one processor to correct the distortions in the transformed image using formulas of:
$$\{ \begin{matrix}x = {x}_{e} ( {k}_{0} + {k}_{1} r + {k}_{2} {r}^{2} + {k}_{3} {r}^{3} + … + {k}_{n} {r}^{n} ) \\ y = {y}_{e} ( {k}_{0} + {k}_{1} r + {k}_{2} {r}^{2} + {k}_{3} {r}^{3} + … + {k}_{n} {r}^{n} )\end{matrix}$$
where (k₀, k₁, k₂, k₃, . . . kₙ) represent the one or more lens distortion coefficients, x and y represent coordinates on the display panel, and r=\sqrt{xₑ²+yₑ²}.
